(19) United States
(12) Patent Application Publication
(10) Pub. No.: US 2018/0343640 A1
(43) Pub. Date: Nov. 29, 2018

(54) BASE STATION APPARATUS AND TRANSMISSION METHOD

(71) Applicant: FUJITSU LIMITED, Kawasaki-shi (JP)

(72) Inventors: TAKAHIRO ARAKI, Yokohama (JP); Yoshiyuki Ono, Komae (JP)

(73) Assignee: FUJITSU LIMITED, Kawasaki-shi (JP)

(21) Appl. No.: 15/986,879

(22) Filed: May 23, 2018

(30) Foreign Application Priority Data
May 25, 2017 (JP) 2017-103826

(51) Int. Cl. H04W 72/04

(52) U.S. Cl. CPC H04W 72/04

(57) ABSTRACT

There is provided a base station apparatus including a memory, a processor coupled to the memory and configured to before success of reception for first data transmitted to a plurality of terminal devices is specified for each of the terminal devices, allocate, to the terminal devices, a first resource for transmitting second data next to the first data, after the success for the first data is specified for each of the terminal devices, convert the first resource allocated to a first terminal device that has failed to receive the first data into a second resource for retransmitting the first data, and a transmitter configured to retransmit the first data to the first terminal device by using the second resource, and transmit the second data to a second terminal device that has succeeded to receive the first data by using the first resource.

### CROSS-REFERENCE TO RELATED APPLICATION

This application is based upon and claims the benefit of priority of the prior Japanese Patent Application No. 2017-103826, filed on May 25, 2017, the entire contents of which are incorporated herein by reference.

### FIELD

The embodiments discussed herein are related to a base station apparatus and a transmission method.

### BACKGROUND

In the long term evolution (LTE) of the 4G (Generation) (the fourth generation communication method), for example, a hybrid automatic repeat request (HARQ) technology is adopted in order to implement an efficient data transmission. In the HARQ, a receiving device requests a transmitting device to re-transmit data failed to be received (decoded) in the processing of a layer 1 protocol layer such as the LTE. Upon being requested for data re-transmission, the transmitting device transmits data related to the original data failed to be received (decoded) by the receiving device, as re-transmission data. The receiving device performs a data decoding by combining the data failed to be received (decoded) and the re-transmission data corresponding to the re-transmission request of the data failed to be received (decoded). This implements a re-transmission control with high efficiency and high accuracy.

Related techniques are disclosed in, for example, Japanese Laid-Open Patent Publication No. 2015-188255.

### SUMMARY

According to an aspect of the invention, a base station apparatus configured to communicate with a plurality of terminal devices, the base station apparatus includes a memory, a processor coupled to the memory and the processor configured to before success of reception for first data transmitted to the plurality of terminal devices is specified for each of the plurality of terminal devices, allocate, to the plurality of terminal devices, a first resource for transmitting second data next to the first data, after the success for the first data is specified for each of the plurality of terminal devices, convert the first resource allocated to a first terminal device of the plurality of terminal devices that has failed to receive the first data into a second resource for retransmitting the first data, and a transmitter configured to re-transmit the first data to the first terminal device by using the second resource, and transmit the second data to a second terminal device of the plurality of terminal devices that has succeeded to receive the first data by using the first resource.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view illustrating the configuration of a wireless communication system according to an embodiment;

FIG. 2 is a block diagram illustrating the configuration of a base station apparatus according to the embodiment;

FIG. 3 is a view for explaining an example of scheduling by a scheduler in the embodiment;

FIG. 4 is a view for explaining another example of scheduling by the scheduler in the embodiment;

FIG. 5 is a flowchart illustrating an example of a processing operation by the base station apparatus according to the embodiment;

FIG. 6 is a flowchart illustrating an example of a processing operation by the base station apparatus according to the embodiment;

FIG. 7 is a view illustrating an example of a processing operation by a base station apparatus according to a comparative example; and

FIG. 8 is a view illustrating an example of a processing operation by the base station apparatus according to the embodiment.

### DESCRIPTION OF EMBODIMENT

In the next generation communication standard (e.g., 5G (the fifth generation mobile communication)), it is expected that the amount of data communication will be greatly increased. Thus, in addition to the standard technology of 4G (the fourth generation mobile communication), it has been studied to implement further lower the delay of communication. For example, in HARQ, a transmitting device re-transmits data to a receiving device that has failed to receive the data while transmitting new data to a receiving device that has succeeded in receiving the data. However, it is expected to shorten the time required for data re-transmission and new data transmission. The time required for data re-transmission and new data transmission refers to the time taken until the re-transmission data and the new data are transmitted from the transmitting device after a response signal indicating a success or failure of reception of data transmitted to the receiving device is received by the transmitting device. The time required for data re-transmission and new data transmission is also called HARQ_RTT (Round Trip Time).

An embodiment of a technique capable of shortening the time required for re-transmission of data and transmission of new data will be described below in detail with reference to the drawings. It should be noted that the disclosed technology is not limited by this embodiment. In the embodiment, components having the same functions are denoted by the same reference numerals and explanation thereof will not be repeated.

### Embodiment

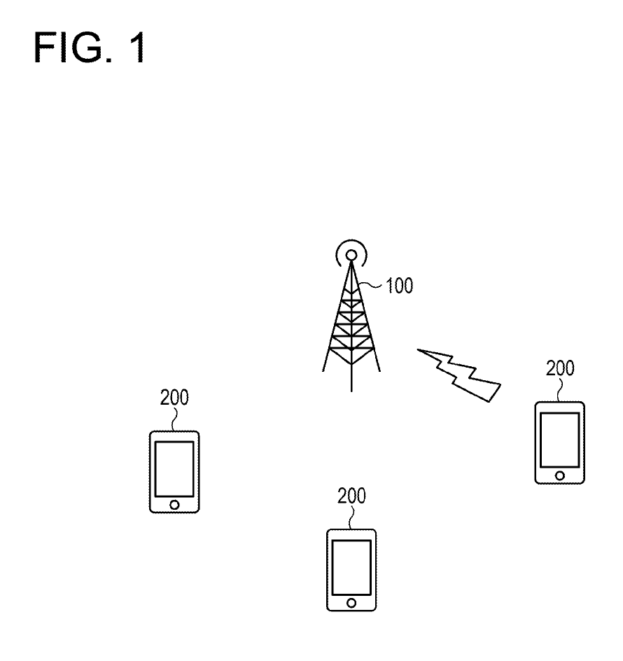

FIG. 1 is a view illustrating the configuration of a wireless communication system according to an embodiment. The wireless communication system illustrated in FIG. 1 includes a base station apparatus 100 and a plurality of terminal devices 200. The terminal device 200 is also called user equipment (UE).

The base station apparatus 100 transmits a signal including data to the plurality of terminal devices 200. The base station apparatus 100 allocates a first resource for new data transmission to the plurality of terminal devices 200 before the success or failure of the reception of the data transmitted to the plurality of terminal devices 200 is specified for each terminal device 200. Specifically, the base station apparatus 100 uses a response signal returned from each terminal device 200 in accordance with the transmitted data to allocate the first resource for new data transmission to all the terminal devices 200 in communication before the success or failure of data reception is specified for each terminal device 200. The response signal returned from each terminal device 200 is ACK (ACKnowledgment) for notifying the success of data reception (decoding) or NACK (Negative ACKnowledgment) for notifying the failure of data reception (decoding).

Then, the base station apparatus 100 uses the response signal to specify the success or failure of data reception for each terminal device 200. Thereafter, the base station apparatus 100 converts the first resource allocated to a terminal device 200 which has failed to receive data into a second resource for data re-transmission. Then, the base station apparatus 100 uses the second resource to re-transmit the data to the terminal device 200 which has failed to receive the data and, at the same time, uses a first resource unconverted into the second resource to transmit new data to the terminal device 200 which has succeeded in receiving the data.

Accordingly, after the success or failure of data reception is specified for each terminal device 200, the process of allocating the first resource for new data transmission may be omitted. Thus, it is possible to promptly start (advance) the data re-transmission and the new data transmission. As a result, it is possible to shorten the time required for data re-transmission and new data transmission, that is, HARQ_RTT.

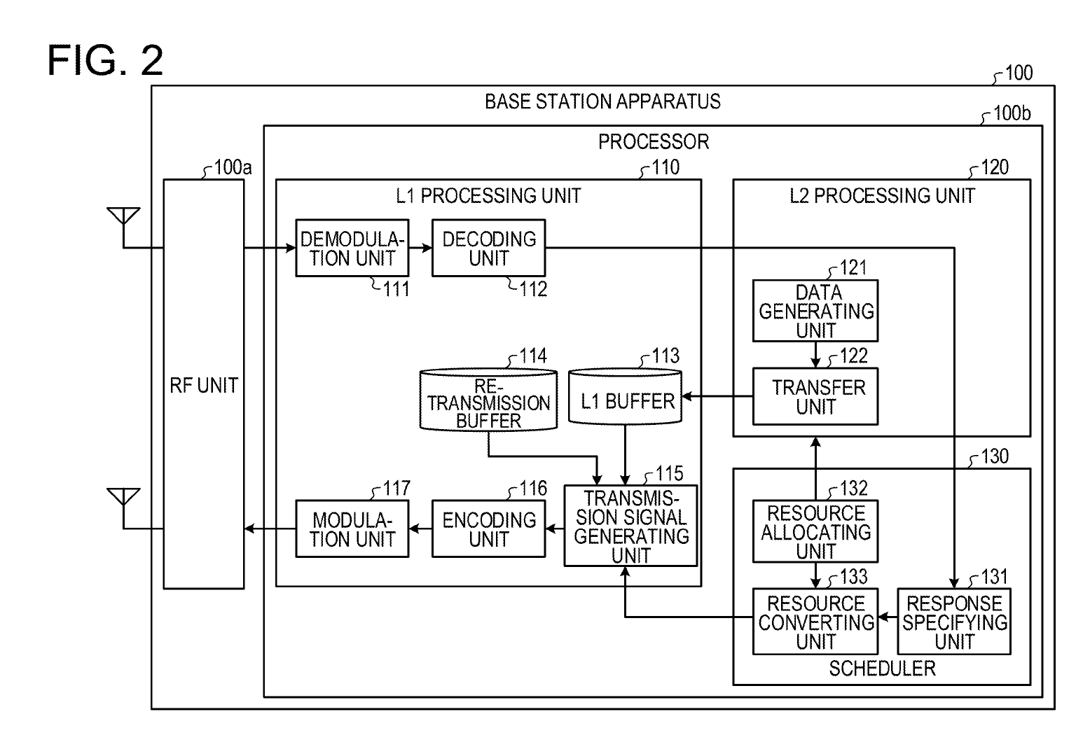

FIG. 2 is a block diagram illustrating the configuration of base station apparatus 100 according to the embodiment. As illustrated in FIG. 2, the base station apparatus 100 includes a radio frequency (RF) unit 100a and a processor 100b.

The RF unit 100a performs a process for mutual conversion between a radio signal which is a high frequency signal and a baseband signal which is a low frequency. That is, the RF unit 100a performs a predetermined radio reception process such as down-conversion and analog-to-digital conversion on an uplink signal received from the terminal device 200 via an antenna, and outputs the uplink signal subjected to the radio reception process to a demodulation unit 111 to be described later. Further, the RF unit 100a performs a predetermined radio transmission process such as digital/analog conversion and up-conversion on a signal received from a modulation unit 117 to be described later, to form a radio signal and transmits the radio signal to the terminal device 200 via the antenna.

The processor 100b includes, for example, a central processing unit (CPU), a field programmable gate array (FPGA), a digital signal processor (DSP) or the like, and integrally controls the entire base station apparatus 100. Specifically, the processor 100b includes an L1 processing unit 110, an L2 processing unit 120 and a scheduler 130.

The L1 processing unit 110 executes a process of Layer 1 (L1). The Layer 1 (L1) includes a physical (PHY) layer.

Specifically, the L1 processing unit 110 includes a demodulation unit 111, a decoding unit 112, an L1 buffer 113, a re-transmission buffer 114, a transmission signal generating unit 115, an encoding unit 116 and a modulation unit 117.

The demodulation unit 111 receives an uplink signal from the RF unit 100a. The demodulation unit 111 demodulates the uplink signal and outputs the demodulated uplink signal to the decoding unit 112.

The decoding unit 112 receives the uplink signal from the demodulation unit 111. The decoding unit 112 decodes the uplink signal to extract a response signal (e.g., ACK or NACK) returned from each terminal device 200 according to the transmitted data. Then, the decoding unit 112 outputs the extracted response signal to a response specifying unit 131 to be described later.

The L1 buffer 113 temporarily holds data output from the L2 processing unit 120 as new data. The L1 buffer 113 corresponds to an example of a buffer of the PHY layer.

The re-transmission buffer 114 temporarily holds the data transmitted from the antenna to the terminal device 200 in preparation for re-transmission. Hereinafter, the data temporarily held in the re-transmission buffer 114 will be referred to as “re-transmission data” as appropriate.

The transmission signal generating unit 115 arranges the new data and the re-transmission data in resources according to scheduling by the scheduler 130, and generates a transmission signal. That is, the transmission signal generating unit 115 acquires re-transmission data from the re-transmission buffer 114 and acquires new data from the L1 buffer 113. Then, the transmission signal generating unit 115 arranges the re-transmission data in the second resource, arranges the new data in the first resource unconverted into the second resource, and generates a transmission signal including the new data and the re-transmission data. The scheduling by the scheduler 130 will be described later.

The encoding unit 116 encodes the transmission signal generated by the transmission signal generating unit 115, and outputs the encoded transmission signal to the modulation unit 117.

The modulation unit 117 receives the transmission signal from the encoding unit 116. The modulation unit 117 modulates the transmission signal and outputs the modulated transmission signal to the RF unit 100a.

The L2 processing unit 120 executes a processing of Layer 2 (L2). The Layer 2 (L2) includes, for example, a packet data convergent protocol (PDCP) layer, a radio link control (RLC) layer and a medium access control (MAC) layer.

Specifically, the L2 processing unit 120 includes a data generating unit 121 and a transfer unit 122.

Before the success or failure of data reception is specified for each terminal device 200, the data generating unit 121 generates new data upon the completion of the allocation of the first resource in the scheduler 130. The new data is, for example, a MAC-PDU obtained by adding a header of the MAC layer to a packet data unit (PDU) of the RLC layer. The new data generating process by the data generating unit 121 is the above-mentioned MAC layer process.

The transfer unit 122 transfers the new data generated by the data generating unit 121 from the MAC layer to the PHY layer and stores the new data in the L1 buffer 113 which is a buffer of the PHY layer. As a result, the transfer of new data from the MAC layer to the PHY layer is advanced before the success or failure of data reception is specified for each terminal device 200.

The scheduler 130 performs scheduling for allocating resources constituting a transmission signal including the re-transmission data and the new data to the plurality of terminal devices 200.

Specifically, the scheduler 130 includes a response specifying unit 131, a resource allocating unit 132 and a resource converting unit 133.

The response specifying unit 131 receives a response signal (e.g., ACK or NACK) from the decoding unit 112. The response specifying unit 131 uses the response signal to specify the success or failure of data reception for each terminal device 200. That is, the response specifying unit 131 determines for each terminal device 200 whether the response signal is ACK or NACK. In accordance with the determination result, the response specifying unit 131 specifies a terminal device 200 that has succeeded in receiving data and a terminal device 200 that has failed to receive data. The response specifying unit 131 outputs information indicating the terminal device 200 that has succeeded in receiving the data and the terminal device 200 that has failed to receive the data to the resource converting unit 133.

The resource allocating unit 132 allocates the first resource for new data transmission to the plurality of terminal devices 200 before the success or failure of data reception for each terminal device 200 is specified by the response specifying unit 131. Specifically, irrespective of the success or failure of data reception, the resource allocating unit 132 allocates the first resource to all the terminal devices 200 in communication until the success or failure of data reception is specified for each terminal device 200 after a signal including the data is transmitted to the plurality of terminal devices 200. Upon the completion of allocation of the first resource, a notification indicating the completion of allocation is output to the L2 processing unit 120.

Further, when allocating the first resource to the plurality of terminal devices 200, the resource allocating unit 132 calculates the number of resource blocks, which is the unit of allocation of the first resource, based on a throughput of each terminal device 200. For example, the resource allocating unit 132 calculates the number of resource blocks so that more first resources are allocated for terminal devices 200 having a larger throughput. The throughput for each terminal device 200 is acquired from a host device of the base station apparatus 100.

The resource converting unit 133 converts the first resource allocated to the terminal device 200 that has failed to receive data into the first resource for data re-transmission after the success or failure of data reception is specified for each terminal device 200 by the response specifying unit 131. Then, information indicating the second resource converted from the first resource and the first resource unconverted into the second resource is output to the transmission signal generating unit 115.

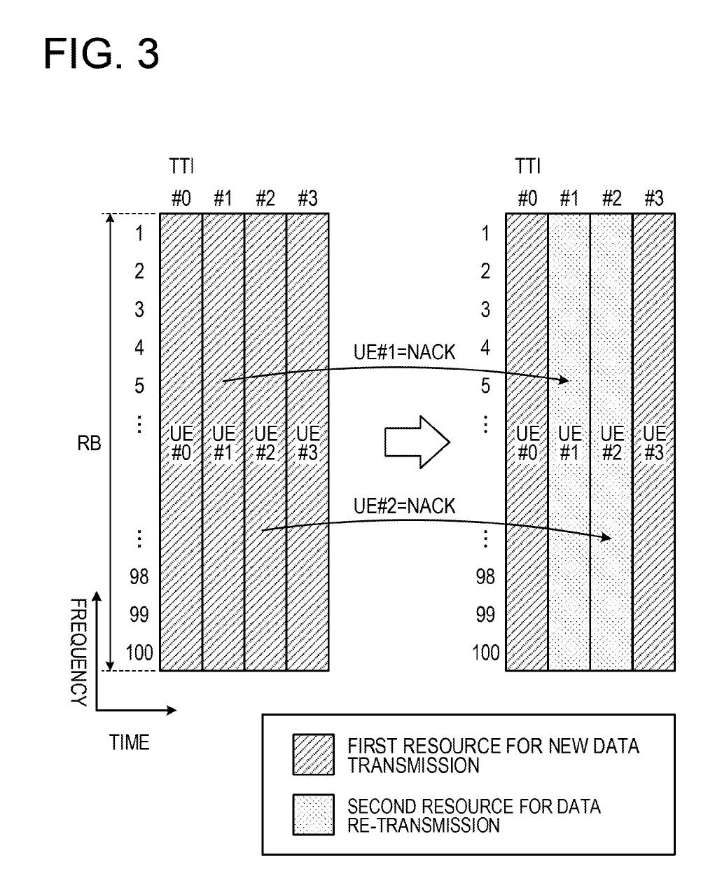

Here, the scheduling by the scheduler 130 will be described in detail. FIG. 3 is a view for explaining an example of the scheduling by the scheduler 130 in the embodiment. FIG. 3 illustrates an example of scheduling in a case where one terminal device 200 (UE#0, UE#1, UE#2 or UE#3) is multiplexed to each of four TTIs (Transmission Time Intervals) (TTI#0 to TTI#3). In 5G, 0.25 ms is assumed as TTI.

First, as illustrated on the left side of FIG. 3, before the success or failure of data reception is specified for each terminal device 200, under the assumption that the response signals from all the terminal devices 200 are ACK, the first resource for new data transmission is allocated to all the terminals devices 200. At this time, the number of resource blocks, which is the unit of allocation of the first resource, is calculated based on the throughput of each terminal device 200. In the example of FIG. 3, 100 resource blocks are allocated as the first resource.

Then, after the success or failure of data reception is specified for each terminal device 200, as illustrated on the right side of FIG. 3, the first resource that has been allocated to the terminal device 200 that has returned NACK as a response signal is converted into the second resource for data re-transmission. In FIG. 3, the first resource that has been allocated to UE#1 that has returned NACK to TTI#1 and the first resource that has been allocated to UE#2 that has returned NACK to TTI#2 are converted into the second resource.

That is, after the success or failure of data reception is specified in a state where the first resource is allocated to all the terminal devices 200, only the first resource that has been allocated to the terminal device 200 which has failed to receive data is converted into the second resource by the resource converting unit 133. Therefore, the base station apparatus 100 may omit the allocation processing of the first resource after the success or failure of data reception is specified for each terminal device 200. As a result, it is possible to shorten the time required for data re-transmission and new data transmission, that is, HARQ_RTT.

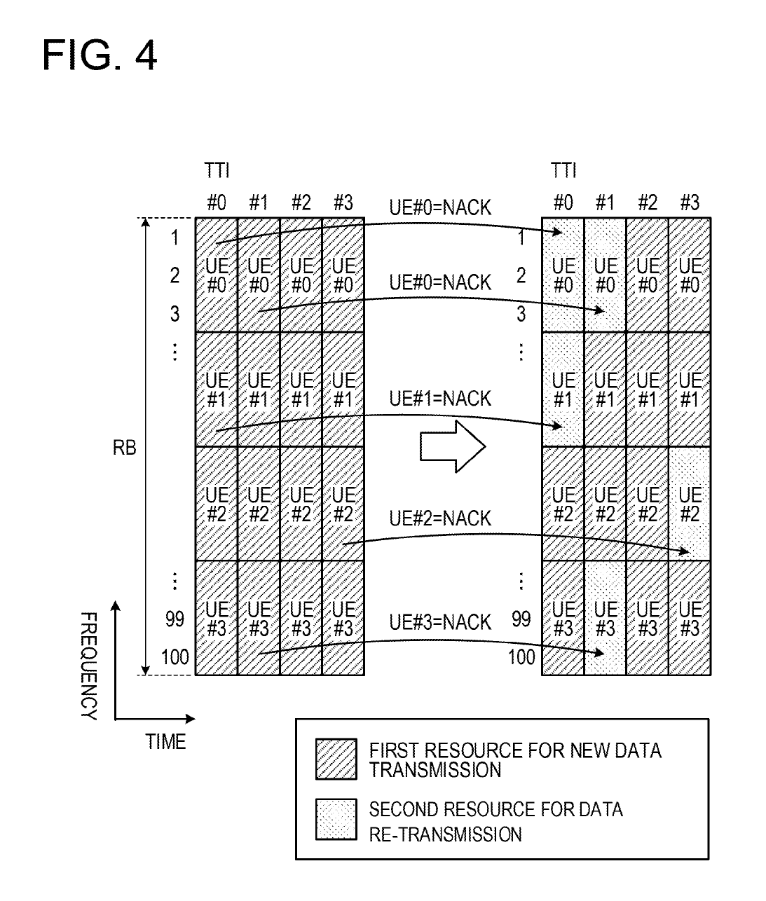

FIG. 4 is a view for explaining another example of the scheduling by the scheduler 130 in the embodiment. FIG. 4 illustrates an example of scheduling in a case where four terminal devices 200 (UE#0, UE#1, UE#2 and UE#3) are multiplexed to each of four TTIs (TTI#0 to TTI#3).

First, as illustrated on the left side of FIG. 4, before the success or failure of data reception is specified for each terminal device 200, under the assumption that the response signals from all the terminal devices 200 are ACK, the first resource for new data transmission is allocated to all the terminals devices 200. At this time, the number of resource blocks, which is the unit of allocation of the first resource, is calculated based on the throughput of each terminal device 200. In the example of FIG. 4, 100 resource blocks are allocated as the first resource.

Then, after the success or failure of data reception is specified for each terminal device 200, as illustrated on the right side of FIG. 4, the first resource that has been allocated to the terminal device 200 that has returned NACK as a response signal is converted into the second resource for data re-transmission. In FIG. 4, the first resource that has been allocated to UE#0 and UE#1 that have returned NACK to TTI#0 and the first resource that has been allocated to UE#0 and UE#3 that has returned NACK to TTI#3 are converted into the second resource.

That is, after the success or failure of data reception is specified in a state where the first resource is allocated to all the terminal devices 200, only the first resource that has been allocated to the terminal device 200 which has failed to receive data is converted into the second resource by the resource converting unit 133. Therefore, the base station apparatus 100 may omit the allocation processing of the first resource after the success or failure of data reception is specified for each terminal device 200. As a result, it is possible to shorten the time required for data re-transmission and new data transmission, that is, HARQ_RTT.

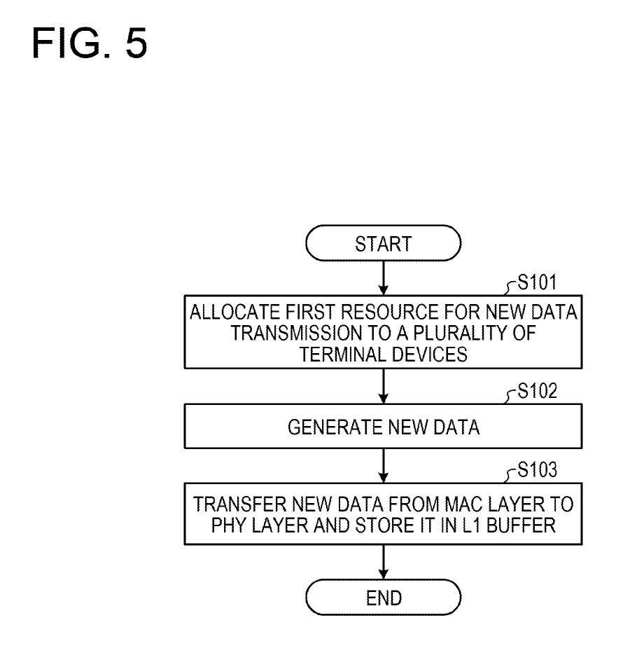

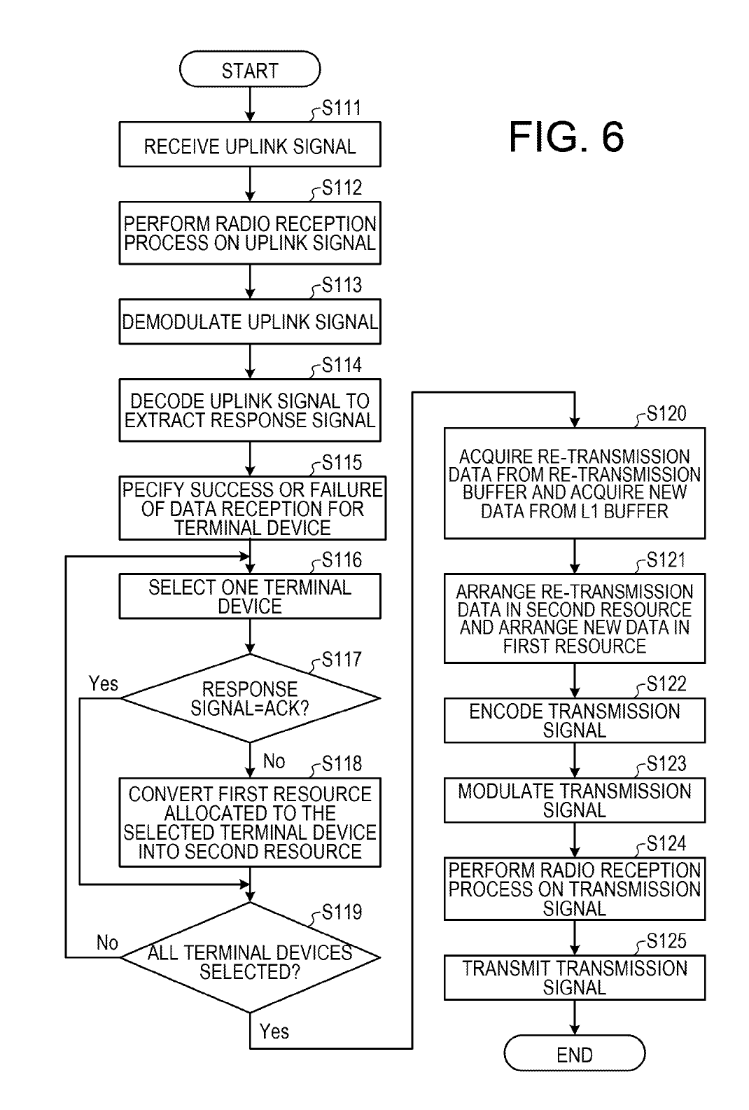

Next, an example of the processing operation by the base station apparatus 100 configured as described above will be described. FIGS. 5 and 6 are flowcharts illustrating an example of the processing operation by the base station apparatus 100 according to the embodiment. The processing operation illustrated in FIG. 5 is performed until the success or failure of data reception is specified for each terminal device 200 after a signal including the data is transmitted from the base station device 100 to the plurality of terminal devices 200 (e.g., until the process of operation S115 is executed).

As illustrated in FIG. 5, when the signal including the data is transmitted from the base station apparatus 100 to the plurality of terminal devices 200, the resource allocating unit 132 allocates the first resource for new data transmission to the plurality of terminal devices 200 (operation S101). At this time, the resource allocating unit 132 calculates the number of resource blocks, which is the unit of allocation of the first resource, based on the throughput of each terminal device 200.

The data generating unit 121 generates new data upon the completion of the allocation of the first resource (operation S102).

The transfer unit 122 transfers the new data generated by the data generating unit 121 from the MAC layer to the PHY layer and stores the new data in the L1 buffer 113 which is a buffer of the PHY layer (operation S103).

As illustrated in FIG. 6, the RF unit 100a receives an uplink signal sent by the terminal device 200 via the antenna (operation S111) and performs the received uplink signal on a predetermined radio reception process (operation S112). Then, the RF unit 100a outputs the uplink signal subjected to the radio reception process to the demodulation unit 111.

The demodulation unit 111 demodulates the uplink signal (operation S113). Then, the demodulation unit 111 outputs the demodulated uplink signal to the decoding unit 112.

The decoding unit 112 decodes the uplink signal to extract a response signal (e.g., ACK or NACK) returned from each terminal device 200 according to the transmitted data (operation S114). Then, the decoding unit 112 outputs the extracted response signal to the response specifying unit 131.

The response specifying unit 131 receives the response signal from the decoding unit 112. Then, the response specifying unit 131 uses the response signal to specify the success or failure of data reception for each terminal device 200 (operation S115). That is, the response specifying unit 131 determines for each terminal device 200 whether the response signal is ACK or NACK, and specifies the terminal device 200 that has succeeded in receiving data and the terminal device 200 that has failed to receive data in accordance with the determination result. The response specifying unit 131 outputs information indicating the terminal device 200 that has succeeded in receiving the data and the terminal device 200 that has failed to receive the data to the resource converting unit 133. Here, the execution of the processing operation illustrated in FIG. 5 is completed before the processing of operation S115 is executed. Therefore, at the point of time when the processing of operation S115 is completed, the first resource for new data transmission is allocated to the plurality of terminal devices 200 and the new data is stored in the L1 buffer 113.

The resource converting unit 133 selects one terminal device 200 from the plurality of terminal devices 200 (operation S116). The resource converting unit 133 determines whether or not the selected terminal device 200 is the terminal device 200 that has succeeded in receiving data (e.g., the terminal device 200 that returned ACK as a response signal) (operation S117).

When the selected terminal device 200 is the terminal device 200 that has failed to receive data (e.g., the terminal device 200 that returned NACK as a response signal) (No in operation S117), the resource converting unit 133 performs the following processing. That is, the resource converting unit 133 converts the first resource allocated to the selected terminal device 200 into the second resource (operation S118).

On the other hand, when the selected terminal device 200 is the terminal device 200 that has failed to receive data (i.e., the terminal device 200 that returned NACK as a response signal) (Yes in operation S117), the resource converting unit 133 does not convert the allocated first resource.

When all the terminal devices 200 are not selected (No in operation S119), the resource converting unit 133 repeats the process of operations S116 to S118. On the other hand, when all the terminal devices 200 are selected (Yes in operation S119), the resource converting unit 133 moves the process to operation S120. At this time, information indicating the second resource into which the first resource is converted and the first resource unconverted into the second resource is output to the transmission signal generating unit 115.

The transmission signal generating unit 115 acquires re-transmission data from the re-transmission buffer 114 and acquires new data from the L1 buffer 113 (operation S120). Then, the transmission signal generating unit 115 arranges the re-transmission data in the second resource, arranges the new data in the first resource unconverted into the second resource, and generates a transmission signal including the new data and the re-transmission data (operation S121).

The encoding unit 116 encodes the transmission signal generated by the transmission signal generating unit 115 (operation S122). Then, the encoding unit 116 outputs the encoded transmission signal to the modulation unit 117.

The modulation unit 117 modulates the transmission signal (operation S123). Then, the modulation unit 117 outputs the modulated transmission signal to the RF unit 100a.

The RF unit 100a performs a predetermined radio transmission process on the transmission signal (operation S124) and transmits the transmission signal subjected to the radio transmission process to the terminal device 200 via the antenna (operation S125). The transmission signal transmitted by the RF unit 100a includes the new data and the re-transmission data. That is, the RF unit 100a uses the second resource to re-transmit the re-transmission data to the terminal device 200 that has failed to receive the data, and uses the first resource unconverted into the second resource to transmit the new data to the terminal device 200 that succeeded in receiving the data. The RF unit 100a is an example of a transmitting unit.

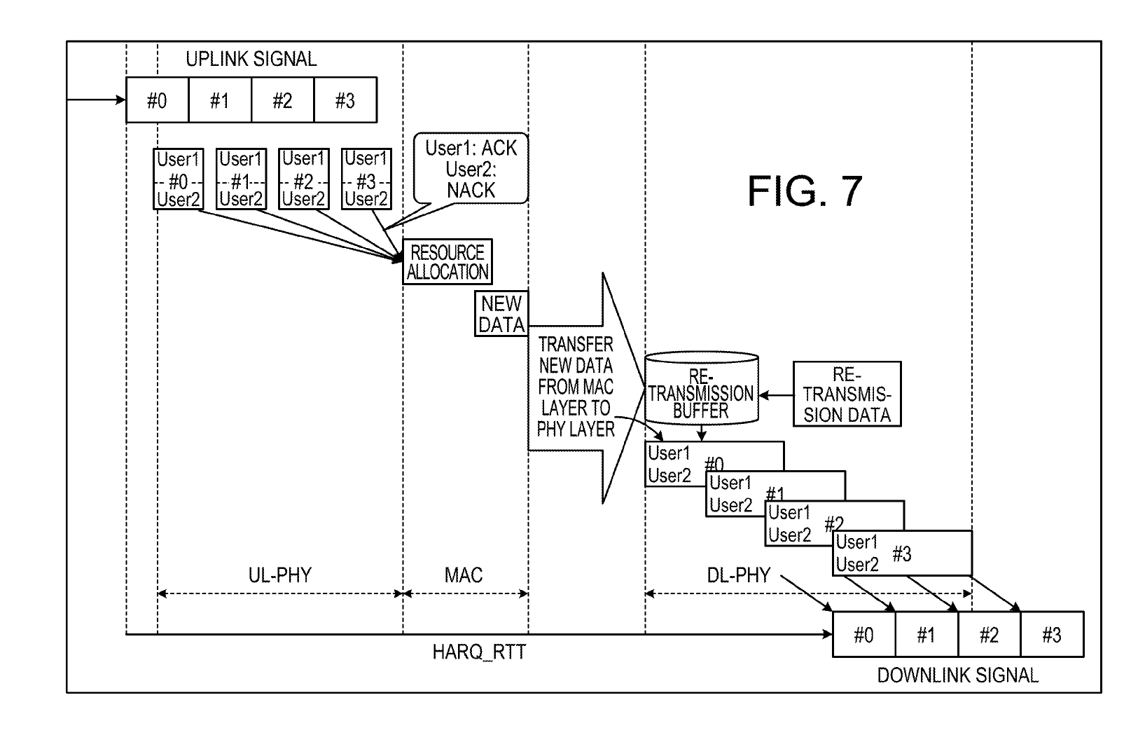

Next, a specific example of the processing operation by the base station apparatus 100 according to the embodiment will be described. First, a comparative example will be described with reference to FIG. 7. The processing operation by the base station apparatus in a case where HARQ of 4G is directly applied for data re-transmission and new data transmission in 5G is illustrated in the comparative example of FIG. 7. FIG. 7 is a view illustrating a specific example of the processing operation by the base station apparatus according to the comparative example. Here, it is assumed that two terminal devices 200 (User1 and User2) are multiplexed to each of four TTIs (TTI#0 to TTI#3). In FIG. 7, “UL-PHY” indicates the processing of a PHY layer for an uplink signal (e.g., demodulation and decoding). “MAC” indicates the processing of a MAC layer (e.g., generation and transfer of new data). “DL-PHY” indicates the processing of the PHY layer for a transmission signal which is a downlink signal (e.g., generation, encoding and modulation of the transmission signal).

In the comparative example illustrated in FIG. 7, after the success or failure of data reception is specified for each terminal device 200, a response signal (e.g., ACK or NACK) extracted by decoding the uplink signal is used to perform a resource allocation process. That is, the first resource for new data transmission is allocated to User1 that returned ACK as a response signal, and the second resource for data re-transmission is allocated to User2 that returned NACK as a response signal. Then, upon the completion of allocation of the first resource and the second resource, the new data is generated and transferred from the MAC layer to the PHY layer. Then, the new data transferred from the MAC layer to the PHY layer is arranged in the first resource and at the same time, the re-transmission data acquired from the re-transmission buffer of the PHY layer is arranged in the second resource to generate a transmission signal. Then, the transmission signal is encoded and modulated, and then is transmitted to User1 and User2 via the antenna.

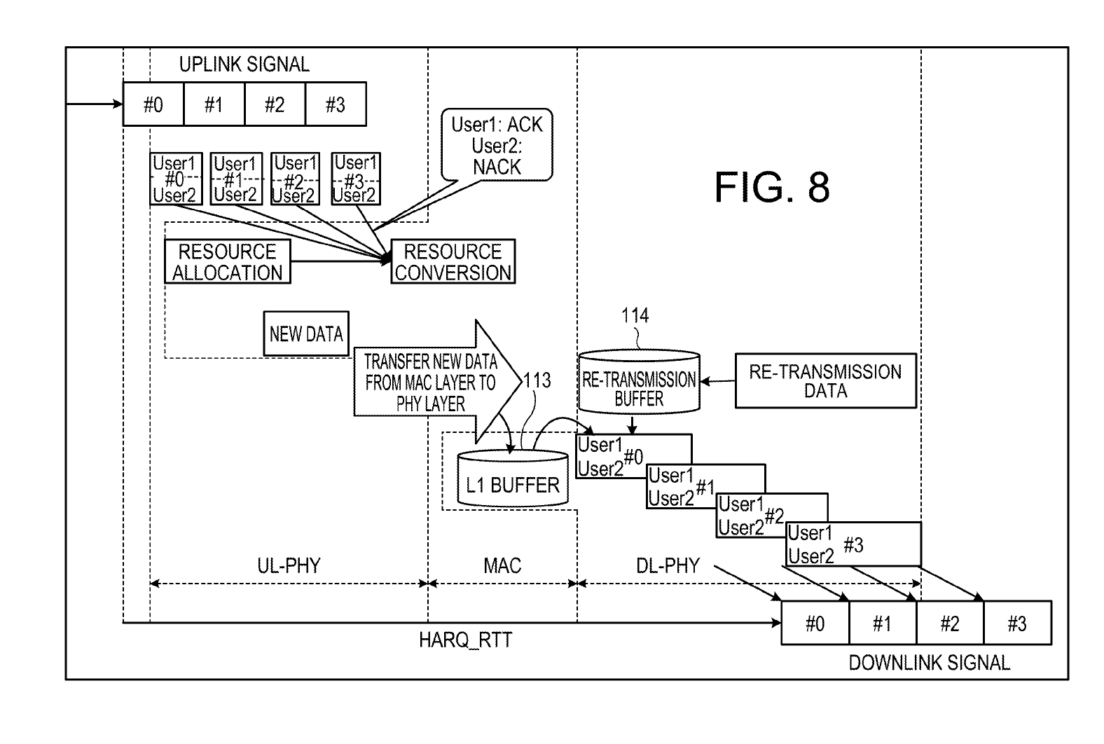

Subsequently, a specific example of the processing operation by the base station apparatus 100 according to the embodiment will be described with reference to FIG. 8. FIG. 8 is a view illustrating a specific example of the processing operation by the base station apparatus according to the embodiment. Here, as in the comparative example, it is assumed that two terminal devices 200 (User1 and User2) are multiplexed to each of four TTIs (TTI#0 to TTI#3). In FIG. 8, “UL-PHY” indicates the processing of a PHY layer for an uplink signal (e.g., demodulation and decoding). “MAC” indicates the processing of a MAC layer (e.g., generation and transfer of new data). “DL-PHY” indicates the processing of the PHY layer for a transmission signal which is a downlink signal (e.g., generation, encoding and modulation of the transmission signal).

In the base station apparatus 100 according to the embodiment, as illustrated in FIG. 8, before the success or failure of data reception is specified for each terminal device 200, a response signal (e.g., ACK or NACK) extracted by decoding the uplink signal is used to perform a resource allocation process. That is, under the assumption that response signals from User1 and User2 are all ACK, the first resource for new data transmission is allocated to User1 and User2. Then, upon the completion of the allocation of the first resource, the new data is generated and transferred from the MAC layer to the PHY layer. Then, the new data transferred from the MAC layer to the PHY layer is stored in the LI buffer 113 which is a buffer of the PHY layer. Then, after the success or failure of data reception is specified for each terminal device 200, the response signal (e.g., ACK or NACK) is used to convert the first resource that has been allocated to User2 that has returned NACK as a response signal into the second resource for data re-transmission. Then, the re-transmission data acquired from the re-transmission buffer of the PHY layer is arranged in the second resource and at the same time, the new data acquired from the L1 buffer 113 is arranged in the first resource to generate a transmission signal. Then, the transmission signal is encoded and modulated, and then is transmitted to User1 and User2 via the antenna.

That is, in the base station apparatus 100 according to the embodiment, after the success or failure of data reception is specified in a state in which the first resource is allocated to User1 and User2, only the first resource that has been allocated to User2 that has failed to receive the data is converted into the second resource. Therefore, the base station apparatus 100 may omit the allocation process of the first resource after the success or failure of data reception is specified for each terminal device. As a result, as compared with the comparative example illustrated in FIG. 7, it is possible to shorten the time required for data re-transmission and new data transmission, that is, HARQ_RTT.

As described above, according to the embodiment, the first resource for new data transmission is allocated to all the terminal devices, and the first resource that has been allocated to a terminal device that has failed to receive data is converted into the second resource. Therefore, since the allocation process of the first resource for new data transmission is able to be omitted after the success or failure of data reception is specified for each terminal device, it is possible to promptly start (advance) the data re-transmission and the new data transmission. As a result, it is possible to shorten the time required for data re-transmission and new data transmission, that is, HARQ_RTT.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A base station apparatus configured to communicate with a plurality of terminal devices, the base station apparatus comprising:
a memory;
a processor coupled to the memory and the processor configured to:
before success of reception for first data transmitted to the plurality of terminal devices is specified for each of the plurality of terminal devices, allocate, to the plurality of terminal devices, a first resource for transmitting second data next to the first data;
after the success for the first data is specified for each of the plurality of terminal devices,
convert the first resource allocated to a first terminal device of the plurality of terminal devices that has failed to receive the first data into a second resource for retransmitting the first data; and
a transmitter configured to re-transmit the first data to the first terminal device by using the second resource, and transmit the second data to a second terminal device of the plurality of terminal devices that has succeeded to receive the first data by using the first resource.

2. The base station apparatus according to claim 1,
wherein the processor is further configured to allocate the first resource according to a throughput of each of the plurality of terminal devices.

3. The base station apparatus according to claim 1,
wherein the processor is further configured to:
generate the second data when the first resource is allocated before the success of reception for the first data is specified for each of the plurality of terminal devices;
transfer the second data generated, from a media access control (MAC) layer to a physical (PHY) layer; and
store the second data transferred to the PHY layer into a buffer of the PHY layer, and
wherein the transmitter is further configured to transmit the second data stored in the buffer by using the first resource.

4. A transmission method for transmitting data from base station apparatus to a plurality of terminal devices, the transmission method comprising:
before success of reception for first data transmitted to the plurality of terminal devices is specified for each of the plurality of terminal devices,
allocating, to the plurality of terminal devices, a first resource for transmitting second data next to the first data, by a processor;
after the success for the first data is specified for each of the plurality of terminal devices,
converting the first resource allocated to a first terminal device of the plurality of terminal devices that has failed to receive the first data into a second resource for retransmitting the first data, by the processor; and
re-transmitting the first data to the first terminal device by using the second resource, and transmitting the second data to a second terminal device of the plurality of terminal devices that has succeeded to receive the first data by using the first resource, by a transmitter.
